(19) United States
(12) Patent Application Publication
(10) Pub. No.: US 2003/0023373 A1
(43) Pub. Date: Jan. 30, 2003

(54) Method for the display of a route

(76) Inventors: Bernd Hessing, Holle (DE); Ansgar Meroth, Leonberg-Gebersheim (DE); Thomas Geisler, Karlsruhe (DE)

Correspondence Address: KENYON & KENYON, ONE BROADWAY, NEW YORK, NY, 10004, US

(21) Appl. No.: 10/110,515

(22) PCT Filed: Jul. 19, 2001
(86) PCT No.: PCT/DE01/02713

(30) Foreign Application Priority Data
Aug. 11, 2000 (DE) 100 39 235.0

(51) Int. Cl. G01C 21/32

(52) U.S. Cl. 701/211; 701/212; 340/995

(57) ABSTRACT

The present invention relates to a method for representing a route for a navigational system.

In order to ensure a representation, having relatively low apparatus cost, which is accurate and does not distract the driver unnecessarily, it is proposed that a route is ascertained between a current position of a vehicle and a destination, a route section of a route is ascertained, starting from the current position, the route section is subdivided into individual subsections, each of which has one driving situation, to each subsection an image unit (1, 2, 3, 4, 5, 6, 11, 12, 13, 21, 22, 23, 31, 32, 33) corresponding to one of its driving situations is allocated, from a predefined quantity of image units, and the image units are positioned in a display field (7, 15) of a read-out mechanism in such a way that successive subsections of the route section are reproduced in adjoining image units (1, 2).

The present invention relates to a method for representing a route. Such a method may particularly be usable in navigational systems of motor vehicles.

In the usual navigational systems, road crossing and turn-off situations are represented differently. On the one hand, a readout unit, especially a display field, such as a video screen, may issue a specific driving instruction. Such an instruction may be, for example, to follow the present course of the road, or to turn off in a particular direction at the next opportunity, to turn around, etc. Such an instruction is given, as a rule, by an arrow representation, possibly having an explanatory text. Such turn-off recommendations are kept very simple, so-that the driver can quickly grasp the following actions without distraction from the current details of the traffic. In the case of more complex crossing situations, such as jug ears and traffic circles, correspondingly more different representations are necessary.

However, the representation of only immediately following situations is often sensed as being unsatisfactory by the driver. In the case of several driving situations following one another, as when there are several exits in a larger crossing system, misunderstandings can easily arise when the driver, for example, does not assign a turn-off recommendation to the correct turn-off or exit. In the case of such systems, the driver often has to react in a short time, since he had not been able to get set for the next driving situation ahead of time.

On the other hand, each crossing situation and turn-off situation may be shown in a larger map. Hereby, the entire situation and the current position of the vehicle are shown However, such map representations mostly distract the driver, since they show a wealth of detail not needed for the particular driving decision, and rather serve the purpose of obtaining a general overview of the position and the destination. For such map representations, as a rule, a corresponding graphical preparation by a graphics processor is necessary, using a high resolution screen, for the construction of graphic commands. For that, the equipment cost is relatively high, and leads to an unnecessary, and in part dangerous distraction of the driver.

The object of the present invention is based on creating improvements as compared to the related art, and particularly to make possible a representation of the route that is simple, and yet safe, and felt by the driver to be agreeable, with a relatively low equipment cost.

This object is attained by the method according to the present invention in that a route between a current position of a vehicle and a destination is ascertained, a section of the route starting at the current position is ascertained, the section is subdivided into individual subsections, each of which has in it one driving situation, to each subsection an image unit is assigned, from a predefined number of image units, which corresponds to one of its driving situations, and the image units are arranged in a display field of a readout meachanism in such a way that successive subsections of the route section are reproduced as adjacent image units.

Thereby, according to the present invention, the data ascertained on the planned route from a navigational system are used to indicate, in each case, only one route section adjacent to the current position of the vehicle. The display of the route section is made via permanent image units taken from a predefined quantity of image units. This makes possible a standardized representation of the subsequent route section by uniform image units that are easy to identify.

The immediately following route section is advantageously broken down into such successive subsections that there is available a corresponding image unit for each subsection. Thereby more complex situations in which, for example, two turn-offs immediately follow each other and a bridge between them, are broken down by subdivision into several image units, each, for example, having a turn-off or a bridge. Herewith, to be sure, one has to accept a stretched-out reproduction of an actually short route section, but the situation may be grasped better by the driver, on account of the stretched out representation, since he can become oriented by additional features, such as bridges reproduced in an image unit, etc.

The image units advantageously differ by their respective symbolic representation, which reflects a simplified representation of each driving situation. Apart from driving straight ahead, this can be particularly a curve, a turn-off from a straight route, a cloverleaf, a bridge, etc. On account of the predefined, limited quantity of various image units, the driver in due course gets to know the meaning of the image unit, so that he can grasp the content of the display field relatively fast.

According to the present invention, particularly more complex route sections having crossings and junctions of individual routes, i.e. not only street plans having tree structures but also network structures can be reproduced.

The representation of image units advantageously takes place in a matrix of rectangular, e.g. square image units.

A perspective representation of the subsequent route section, felt to be agreeable by the driver, can be made on the one hand, by diminishing in size of the following symbols in each case in the image units, and on the other hand, by tapering of the symbols in the image units.

The present invention is explained in greater detail below, in the light of the accompanying drawings and some specific embodiments. The figures show:

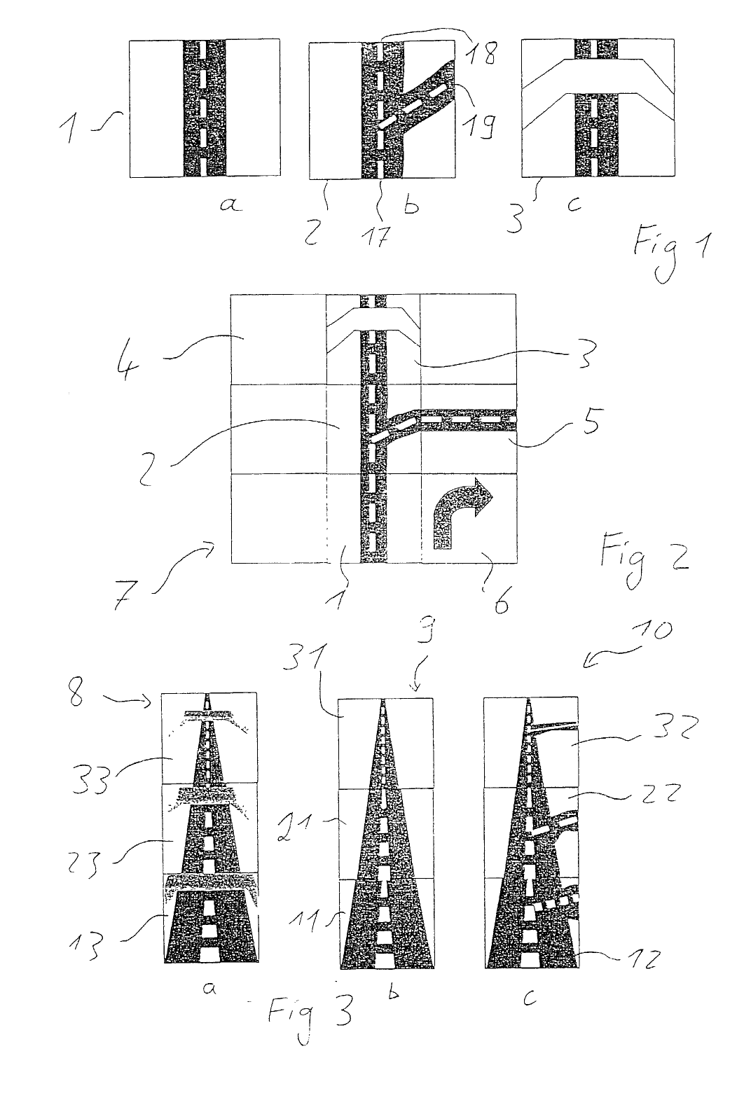

FIG. 1 a selection from image units according to the present invention;

FIG. 2 a display field having several image units;

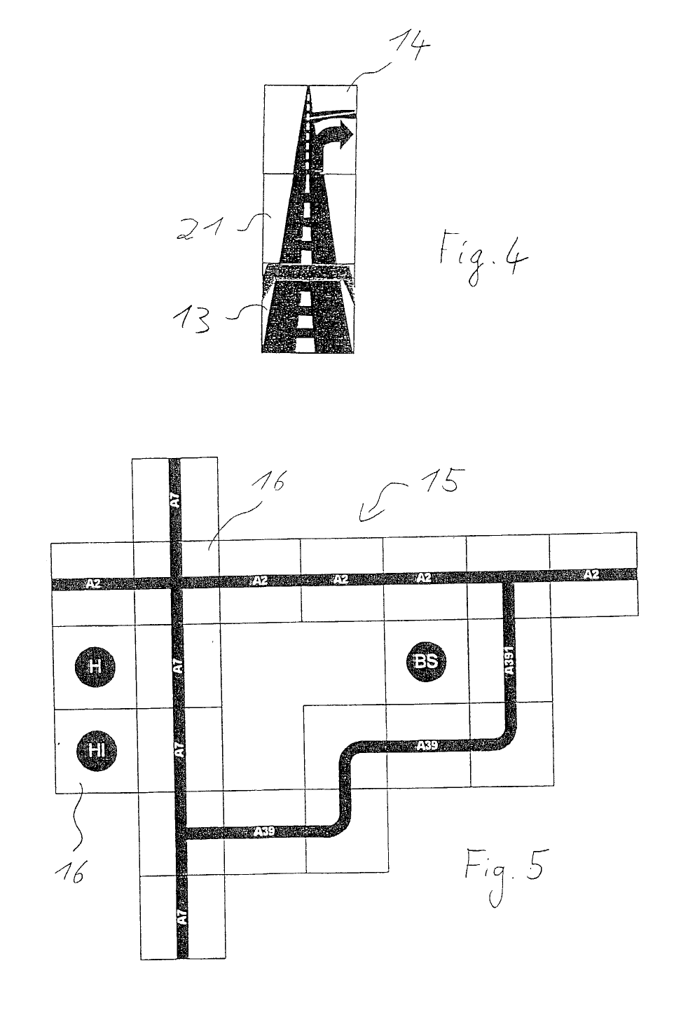

FIG. 3 several sections from a display field having several image units;

FIG. 4 a further image section from a display field;

FIG. 5 a display field of a complex route section.

In FIGS. 1a, b, c an image unit 1 for driving straight ahead, an image unit 2 for a right turn and an image unit 3 for a drive straight ahead having a crossing bridge are shown.

Such image units, and others, are combined in FIG. 2 to a display field made up of nine image units in a 3×3 matrix. In this display field the driver may recognize a route section which adjoins the current position of his vehicle which is positioned at the lower middle end of display field 7. According to this, the driver can first of all follow the course of the road without special driving situations according to image unit 1. Thereafter, the traveled road has a turn-off to the right according to image unit 2, so that the driver has the choice between driving straight ahead and leaving the road by turning into the road branching off to the right. The road continuing in the current driving direction has a bridge crossing the road further down, according to image unit 3, in a manner also recognizable by the driver. The arrow in image unit 6 recommends to the driver leaving the road being used at this moment, by turning according to image unit 2 and continuing on the new road according to image unit 5. Showing the bridge in image unit 3 is thus of advantage to the driver, since he can orient himself by the bridge visible to him during the drive, and he knows he should turn right before the bridge. Image units 4 having free symbols or rather no symbols do not distract the driver from the important image units.

The image units advantageously have fixed connecting points, at which corresponding representations of the route by bordering image units directly adjoin. This is shown in FIG. 1b by an example of a turn-off through a lower connecting point 17, an upper connecting point 18 and a right, sidewise connecting point 19. Advantageously, the connecting points are arranged in a middle position of the respective edge of the image unit, so that bordering image units correspond in a uniform manner in their connecting points.

In the image sections of FIGS. 3a, b, c, the symbols of adjoining image units 13, 23, 33; 11, 21, 31; 12, 22, 32 are in each case reproduced scaled down in successive image units. Thereby the symbols taper from a lower to an upper end. Thus a perspective impression is created for the driver when he is looking at picture sections 8, 9, 10, on account of the tapering as well as the scaling down of the image sections of successive subsections of the route section. As may be seen especially in FIG. 3b and FIG. 3c, during the transition of the symbols of the individual image units, smaller step changes may definitely be created in the side edges of the road represented as well as in the middle stripe sections, without this being disturbing to the driver. When he recognizes the perspective representation of the route, the driver unconsciously supplements smaller discrepancies into a route section recognized by him as meaningful and continuous. Thus, using a limited quantity of image units having relatively few enlargement steps, a plurality of driving situations may be reproduced by the driver as perspectively illustrated driving situations.

FIG. 4 shows a further perspective representation of the route, in which the driver first drives under a bridge as in image unit 13, and after a further section of the course of the road, as in image unit 21, may choose the turn-off to the right shown in image unit 14 if a turn is recommended.

The illustration according to the present invention may also be used to reproduce larger route sections. Thus, according to FIG. 5, a greater region, e.g. an express highway section may be shown, which informs the driver on several express highway connections. Thus, on the one hand, the driver may gather, for his information, an overview of the road network adjacent to his current position. On the other hand, at the occurrence of higher traffic volume as well as traffic jams, he can automatically pick a detour. Such a representation can also be chosen by a driver for the selection of a desired arterial road in and out of a city. According to FIG. 5, it is also possible to represent in this manner a network structure of roads.

According to the present invention, it is possible to represent additional information on the driver's current route section, without telling the driver unnecessary details on the surroundings. This representation can be achieved at relatively low cost by the choice of various image units for different driving situations, possibly also in several enlargement steps for a perspective representation.

Advantageously, the various image units are stored as bit map data files or raster graphics data files in a memory. Advantageously, a nonvolatile memory is used for this, which can store these bit maps permanently. To illustrate a route, the bit map data files or raster graphics data files are copied, by a copying device provided for this, from the memory into the display memory of the display equipment, so that they may be shown directly on the display equipment.

What is claimed is:

1. A method for representing a route, in which
a route is ascertained between a current position of a vehicle and a destination,
a route section of the route is ascertained, starting from the current position,
the route section is subdivided into individual subsections which each have one driving situation,
each subsection is allocated an image unit (1, 2, 3, 4, 5, 6, 11, 12, 13, 21, 22, 23, 31, 32, 33) corresponding to its driving situation, from a predefined quantity of image units, and
the image units are positioned in a display field (7, 15) of a read-out mechanism in such a way that successive subsections of the route section are reproduced in adjoining image units (1, 2).

2. The method as recited in claim 1,
wherein the route section is subdivided into subsections in such a way that one corresponding image unit in the quantity of image units is present for each subsection.

3. The method as recited in claim 1 or 2,
wherein all image units (1, 2, 3, 4, 5, 6, 11, 12, 13, 14, 21, 22, 23, 31, 32, 33) have the same format.

4. The method as recited in claim 3,
wherein the image units each have a rectangular, preferably a square format.

5. The method as recited in claim 3 or 4,
wherein the image units in the display field are positioned in a matrix of lines and columns.

6. The method as recited in one of claims 1 through 5,
wherein the image unit (1, 11, 12, 13) of a subsection following the current position of the vehicle is positioned at a lower edge of the display field.

7. The method as recited in one of claims 1 through 6,
wherein at least for some image units, preferably for image units of subsections having a turn instruction for the vehicle, a directional specification, e.g. by an arrow, is provided.

8. The method as recited in claim 7,
wherein the directional specification is reproduced in the image unit of the subsection having a turn instruction or in an adjoining image unit.

9. The method as recited in one of claims 1 through 8,
wherein image units (21, 22, 23) of subsequent subsections of the route section are allocated smaller symbols than image units (11, 12, 13) of preceding subsections.

10. The method as recited in one of claims 1 through 9,
wherein the quantity of image units has an image unit (1) for driving straight ahead, an image unit (3) for driving straight ahead and having a bridge, an image unit (2) for a turn and an image unit (16) for a superhighway cloverleaf.

11. The method as recited in one of claims 1 through 10,
wherein the image units are stored as bit map data files or raster graphics data files in a memory, preferably a nonvolatile memory, the bit map data files or the raster graphics data files being copied from the memory to a display memory of the display device with the aid of a copying device, for the representation of the route.
